(19) United States
(12) Patent Application Publication
(10) Pub. No.: US 2025/0148646 A1
(43) Pub. Date: May 8, 2025

(54) MESH DECODING DEVICE, MESH ENCODING DEVICE, MESH DECODING METHOD, AND PROGRAM

(71) Applicant: KDDI CORPORATION, Tokyo (JP)

(72) Inventors: Hitoshi NISHIMURA, Fujimino-shi (JP); Kei KAWAMURA, Fujimino-shi (JP)

(73) Assignee: KDDI CORPORATION, Tokyo (JP)

(21) Appl. No.: 19/013,332

(22) Filed: Jan. 8, 2025

Related U.S. Application Data
(63) Continuation of application No. PCT/JP2023/008650, filed on Mar. 7, 2023.

(30) Foreign Application Priority Data
Jul. 9, 2022 (JP) 2022-110865

(51) Int. Cl. G06T 9/00; H04N 19/61; H04N 19/63

(52) U.S. Cl. CPC G06T 9/00; H04N 19/61; H04N 19/63

(57) ABSTRACT

A mesh decoding device includes: a circuit that decodes a displacement bit stream to generate and output a displacement, wherein the circuit: outputs a video by decoding the displacement bit stream by video encoding, develops and outputs the video as a level value for each image, generates a transformed coefficient by inversely quantizing the level values, and generates the displacement by applying an inverse wavelet transform to the transformed coefficient.

### CROSS-REFERENCE TO RELATED APPLICATIONS

The present application is a continuation of PCT Application No. PCT/JP2023/008650, filed on Mar. 7, 2023, which claims the benefit of Japanese patent application No. 2022-110865 filed on Jul. 9, 2022, the entire contents of each application being incorporated herein by reference in its entirety.

### TECHNICAL FIELD

The present invention relates to a mesh decoding device, a mesh encoding device, a mesh decoding method, and a program.

### BACKGROUND ART

Reference 1 discloses a technique for encoding a mesh using Reference 2.
Reference 1: Cfp for Dynamic Mesh Coding, ISO/IEC JTC1/SC29/WG7 N00231, MPEG136—Online
Reference 2: Google Draco, access on May 26, 2022 [Online], https://google.github.io/draco

### SUMMARY OF THE INVENTION

However, in the related art, since the coordinates and connection information of all the vertices constituting the dynamic mesh are losslessly encoded, there is a problem that the amount of information cannot be reduced even under a condition where loss is allowed, and encoding efficiency is low.

Therefore, the present invention has been made in view of the above-described problems, and an object of the present invention is to provide a mesh decoding device, a mesh encoding device, a mesh decoding method, and a program capable of improving encoding efficiency of a mesh.

The first aspect of the present invention is summarized as a mesh decoding device including: a circuit that decodes a displacement bit stream to generate and output a displacement, wherein the circuit: outputs a video by decoding the displacement bit stream by video encoding, develops and outputs the video as a level value for each image, generates a transformed coefficient by inversely quantizing the level values, and generates the displacement by applying an inverse wavelet transform to the transformed coefficient.

The second aspect of the present invention is summarized as a mesh decoding method including: outputting a video by decoding a displacement bit stream by a video coding method; generating a level value by developing the video for each image; generating a transformed coefficient by inversely quantizing the level values; and generating a displacement by applying an inverse wavelet transform to the transformed coefficient.

The third aspect of the present invention is summarized as a program stored on a non-transitory computer-readable medium for causing a computer to function as a mesh decoding device, the mesh decoding device including circuit that decode a displacement bit stream to generate and output a displacement, wherein the circuit: outputs a video by decoding the displacement bit stream by video encoding, outputs a level value by developing the video for each image, generates a transformed coefficient by inversely quantizing the level values, and s generates the displacement by applying an inverse wavelet transform to the transformed coefficient.

According to the present invention, it is possible to provide a mesh decoding device, a mesh encoding device, a mesh decoding method, and a program capable of improving encoding efficiency of a mesh.

### BRIEF DESCRIPTION OF THE DRAWINGS

FIG. 1 is a diagram illustrating an example of a configuration of a mesh processing system 1 according to an embodiment.

FIG. 2 is a diagram illustrating an example of functional blocks of a mesh decoding device 200 according to an embodiment.

FIG. 3A is a diagram illustrating an example of a base mesh and a subdivided mesh.

FIG. 3B is a diagram illustrating an example of a base mesh and a subdivided mesh.

FIG. 4 is a diagram illustrating an example of a syntax configuration of a base mesh bit stream.

FIG. 5 is a diagram illustrating an example of a syntax configuration of a BPH.

FIG. 6 is a diagram illustrating an example of functional blocks of a base mesh decoding unit 202 of the mesh decoding device 200 according to an embodiment.

FIG. 7 is a diagram illustrating an example of a correspondence between vertices of a base mesh of a P frame and vertices of a base mesh of an I frame.

FIG. 8 is a diagram illustrating an example of functional blocks of an inter decoding unit 202E of the base mesh decoding unit 202 of the mesh decoding device 200 according to an embodiment.

FIG. 9 is a diagram for explaining an example of a method of calculating an MVP of a vertex to be decoded by a motion vector prediction unit 202E3 of the inter decoding unit 202E of the base mesh decoding unit 202 of the mesh decoding device 200 according to an embodiment.

FIG. 10 is a flowchart illustrating an example of an operation of the motion vector prediction unit 202E3 of the inter decoding unit 202E of the base mesh decoding unit 202 of the mesh decoding device 200 according to an embodiment.

FIG. 11 is a flowchart illustrating an example of an operation in which the motion vector prediction unit 202E3 of the inter decoding unit 202E of the base mesh decoding unit 202 of the mesh decoding device 200 according to an embodiment calculates a sum Total_D of distances to surrounding vertices that have been decoded.

FIG. 12 is a flowchart illustrating an example of an operation in which the motion vector prediction unit 202E3 of the inter decoding unit 202E of the base mesh decoding unit 202 of the mesh decoding device 200 according to an embodiment calculates an MVP using a weighted average.

FIG. 13 is a flowchart illustrating an example of an operation in which the motion vector prediction unit 202E3 of the inter decoding unit 202E of the base mesh decoding unit 202 of the mesh decoding device 200 according to an embodiment selects an MV as an MVP from a set of candidate MVs.

FIG. 14 is a flowchart illustrating an example of an operation in which the motion vector prediction unit 202E3 of the inter decoding unit 202E of the base mesh decoding unit 202 of the mesh decoding device 200 according to an embodiment creates a set of candidate MVs.

FIG. 15 is a diagram for explaining an example of parallelogram prediction.

FIG. 16 is a flowchart illustrating an example of an operation of returning MVR accuracy to original bit accuracy from adaptive_mesh_flag, adaptive_bit_flag, and an accuracy control parameter that are control information generated by decoding a base mesh bit stream.

FIG. 17 is a diagram for explaining an example of MVR encoding.

FIG. 18 is a diagram illustrating an example of functional blocks of the inter decoding unit 202E of the base mesh decoding unit 202 of the mesh decoding device 200 according to an embodiment.

FIG. 19 is a diagram illustrating an example of an operation of determining connection information and an order of vertices using Edgebreaker.

FIG. 20 is a diagram illustrating an example of functional blocks of a subdivision unit 203 of the mesh decoding device 200 according to an embodiment.

FIG. 21 is a diagram illustrating an example of functional blocks of a base mesh subdivision unit 203A of the subdivision unit 203 of the mesh decoding device 200 according to an embodiment.

FIG. 22 is a diagram for explaining an example of a method of dividing a base face by a base face division unit 203A5 of the base mesh subdivision unit 203A of the subdivision unit 203 of the mesh decoding device 200 according to an embodiment.

FIG. 23 is a flowchart illustrating an example of an operation of the base mesh subdivision unit 203A of the subdivision unit 203 of the mesh decoding device 200 according to an embodiment.

FIG. 24 is a diagram illustrating an example of functional blocks of a subdivided mesh adjustment unit 203B of the subdivision unit 203 of the mesh decoding device 200 according to an embodiment.

FIG. 25 is a diagram illustrating an example of a case where an edge division point on a base face ABC is moved by an edge division point moving unit 701 of the subdivided mesh adjustment unit 203B of the subdivision unit 203 of the mesh decoding device 200 according to an embodiment.

FIG. 26 is a diagram illustrating an example of a case where a subdivided face X in the base face is subdivided again by a subdivided face division unit 702 of the subdivided mesh adjustment unit 203B of the subdivision unit 203 of the mesh decoding device 200 according to an embodiment.

FIG. 27 is a diagram illustrating an example of a case where all the subdivided faces are subdivided again by the subdivided face division unit 702 of the subdivided mesh adjustment unit 203B of the subdivision unit 203 of the mesh decoding device 200 according to an embodiment.

FIG. 28 is a diagram illustrating an example of functional blocks of a displacement decoding unit 206 of the mesh decoding device 200 according to an embodiment (in a case where inter-prediction is performed in a spatial domain).

FIG. 29 is a diagram illustrating an example of a configuration of a displacement bit stream.

FIG. 30 is a diagram illustrating an example of a syntax configuration of a DPS.

FIG. 31 is a diagram illustrating an example of a syntax configuration of a DPH.

FIG. 32 is a diagram for explaining an example of a correspondence of subdivided vertices between a reference frame and a frame to be decoded in a case where inter-prediction is performed in a spatial domain.

FIG. 33 is a diagram illustrating an example of functional blocks of a displacement decoding unit 206 of the mesh decoding device 200 according to an embodiment (in a case where inter-prediction is performed in a frequency domain).

FIG. 34 is a diagram for explaining an example of a correspondence of frequencies between a reference frame and a frame to be decoded in a case where inter-prediction is performed in a frequency domain.

FIG. 35 is a flowchart illustrating an example of an operation of the displacement decoding unit 206 of the mesh decoding device 200 according to an embodiment.

FIG. 36 is a diagram illustrating an example of functional blocks of a displacement decoding unit 206 according to a first modification.

FIG. 37 is a diagram illustrating an example of functional blocks of the displacement decoding unit 206 according to a second modification.

FIG. 38 is a diagram illustrating an example of functional blocks of the inter decoding unit 202E of the base mesh decoding unit 202 of the mesh decoding device 200 according to an embodiment.

FIG. 39 is a diagram illustrating an example of functional blocks of an intra decoding unit 202B of the base mesh decoding unit 202 of the mesh decoding device 200 according to an embodiment.

### DESCRIPTION OF EMBODIMENTS

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

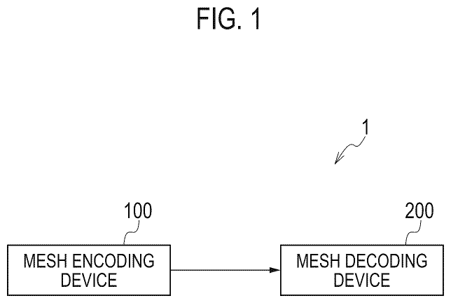

Hereinafter, a mesh processing system according to the present embodiment will be described with reference to FIGS. 1 to 35.

FIG. 1 is a diagram illustrating an example of a configuration of a mesh processing system 1 according to the present embodiment. As illustrated in FIG. 1, the mesh processing system 1 includes a mesh encoding device 100 and a mesh decoding device 200.

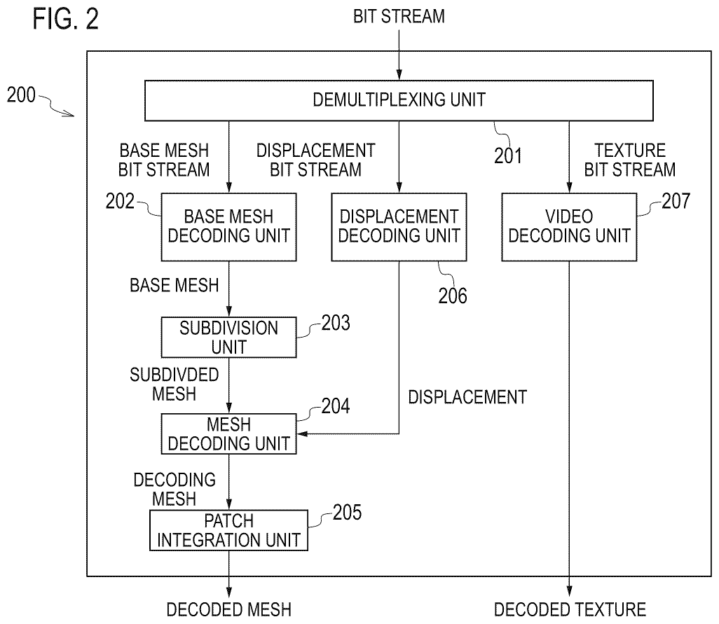

FIG. 2 is a diagram illustrating an example of functional blocks of the mesh decoding device 200 according to the present embodiment.

As illustrated in FIG. 2, the mesh decoding device 200 includes a demultiplexing unit 201, a base mesh decoding unit 202, a subdivision unit 203, a mesh decoding unit 204, a patch integration unit 205, a displacement decoding unit 206, and a video decoding unit 207.

Here, the base mesh decoding unit 202, the subdivision unit 203, the mesh decoding unit 204, and the displacement decoding unit 206 may be configured to perform processing in units of patches obtained by dividing the mesh, and then may be configured to integrate the processing results by the patch integration unit 205.

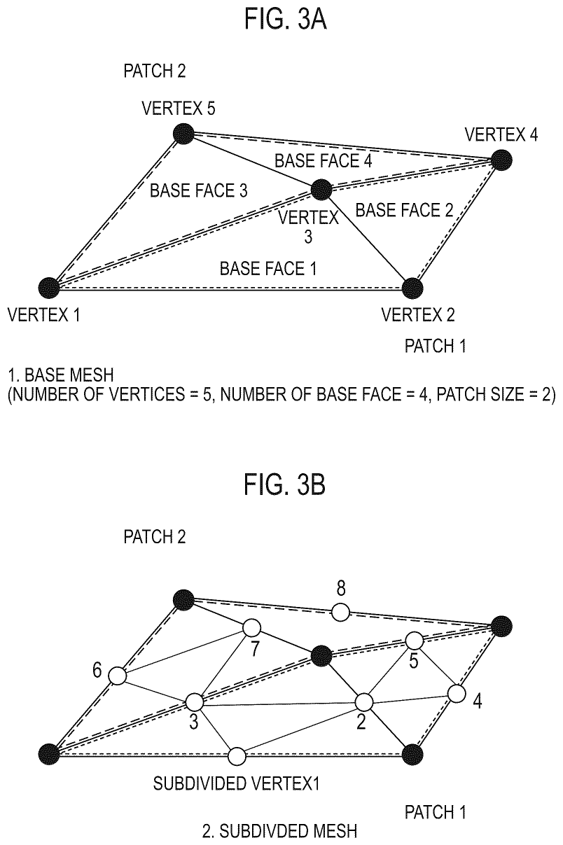

In the example of FIG. 3A, the mesh is divided into a patch 1 configured by base faces 1 and 2 and a patch 2 configured by base faces 3 and 4.

The demultiplexing unit 201 is configured to separate the multiplexed bit stream into a base mesh bit stream, a displacement bit stream, and a texture bit stream.

### <Base Mesh Decoding Unit 202>

The base mesh decoding unit 202 is configured to decode the base mesh bit stream, and generate and output the base mesh.

Here, the base mesh includes a plurality of vertices in a three-dimensional space and edges connecting the plurality of vertices.

As illustrated in FIG. 3A, the base mesh is configured by combining base faces represented by three vertices.

The base mesh decoding unit 202 may be configured to decode the base mesh bit stream using, for example, Draco described in Reference 2.

Furthermore, the base mesh decoding unit 202 may be configured to generate “subdivision_method_id” described later as control information for controlling the type of the subdivision method.

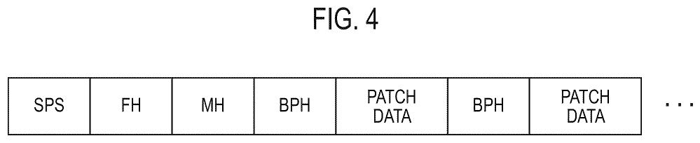

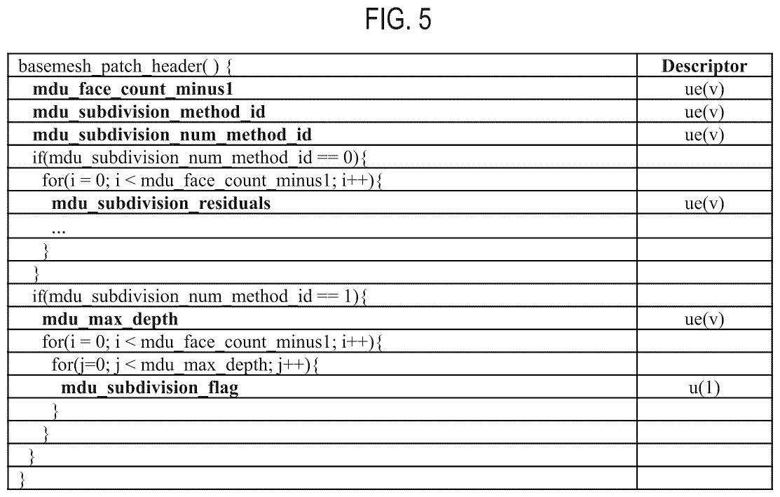

Hereinafter, the control information decoded by the base mesh decoding unit 202 will be described with reference to FIGS. 4 and 5.

FIG. 4 is a diagram illustrating an example of a syntax configuration of the base mesh bit stream.

As illustrated in FIG. 4, firstly, the base mesh bit stream may include a base patch header (BPH) that is a set of control information corresponding to the meshpatch. Second, the base mesh bit stream may include meshpatch data obtained by encoding the meshpatch next to the BPH.

As described above, the base mesh bit stream has a configuration in which the BPH corresponds to each patch data one by one. Note that the configuration of FIG. 4 is merely an example, and elements other than those described above may be added as constituent elements of the base mesh bit stream as long as the BPH corresponds to each patch data.

For example, as illustrated in FIG. 4, the base mesh bit stream may include a sequence parameter set (SPS), may include a frame header (FH) which is a set of control information corresponding to a frame, or may include a mesh header (MH) which is control information corresponding to a mesh.

FIG. 5 is a diagram illustrating an example of a syntax configuration of a BPH. Here, if syntax functions are similar, syntax names different from the syntax names illustrated in FIG. 5 may be used.

In the syntax configuration of the BPH illustrated in FIG. 5, the Description column indicates how each syntax is encoded. Further, ue(v) means an unsigned 0-order exponential-Golomb code, and u(n) means a n-bit flag.

The BPH includes at least a control signal (mdu_face_count_minus1) that designates the number of base faces included in the meshpatch.

Further, the BPH includes at least a control signal (mdu_subdivision_method_id) that designates the type of the subdivision method of the base mesh for each meshpatch.

In addition, the BPH may include a control signal (mdu_subdivision_num_method_id) that designates the type of the subdivision number generation method for each meshpatch. For example, when mdu_subdivision_num_method_id=0, it may be defined that the number of subdivisions of the base face is generated by a prediction division residual, and when mdu_subdivision_num_method_id=1, it may be defined that the number of subdivisions of the base face is recursively generated.

The BPH may include a control signal (mdu_subdivision_residuals) that designates the prediction division residual of the base face for each index i (i=0, . . . , mdu_face_count_minus1) when the number of subdivisions of the base face is generated by the prediction division residual.

The BPH may include a control signal (mdu_max_depth) for identifying an upper limit of the number of times of subdivision recursively performed for each meshpatch when the number of subdivisions of the base face is recursively generated.

The BPH may include a control signal (mdu_subdivision_flag) that designates whether to recursively subdivide the base face for each of the indexes i (i=0, . . . , mdu_face_count_minus1) and j (j=0, . . . , mdu_subdivision_depth_index).

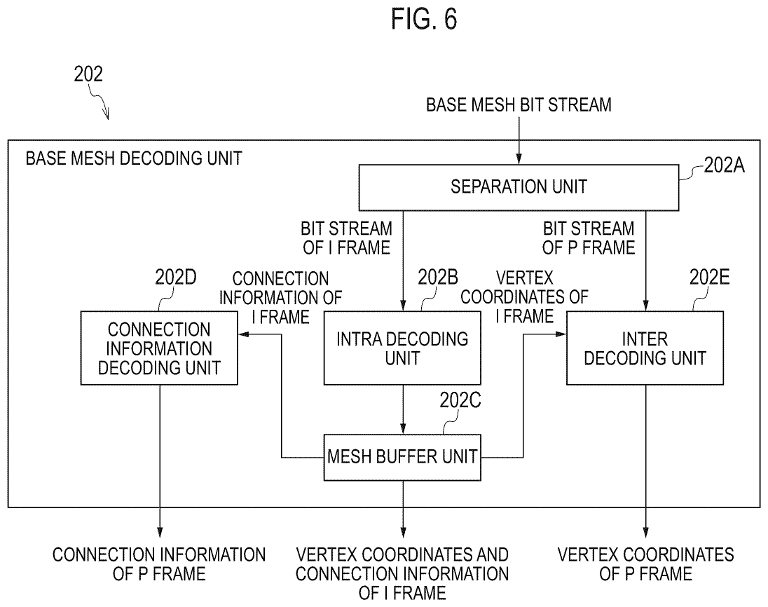

As illustrated in FIG. 6, the base mesh decoding unit 202 includes a separation unit 202A, an intra decoding unit 202B, a mesh buffer unit 202C, a connection information decoding unit 202D, and an inter decoding unit 202E.

The separation unit 202A is configured to classify the base mesh bit stream into an I-frame (reference frame) bit stream and a P-frame bit stream.

### (Intra Decoding Unit 202B)

The intra decoding unit 202B is configured to decode the coordinates of the vertices of the I frame and the connection information from the bit stream of the I frame using, for example, Draco described in Reference 2.

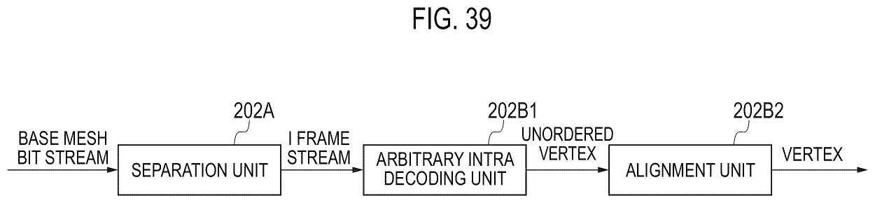

FIG. 39 is a diagram illustrating an example of functional blocks of the intra decoding unit 202B.

As illustrated in FIG. 39, the intra decoding unit 202B includes a separation unit 202A, an arbitrary intra decoding unit 202B1, and an alignment unit 202B2.

The arbitrary intra decoding unit 202B1 is configured to decode the coordinates and the connection information of the unordered vertex of the I frame from the bit stream of the I frame using an arbitrary method including Draco described in Reference 2.

The alignment unit 202B2 is configured to output the vertices by rearranging the unordered vertices in a predetermined order.

As the predetermined order, for example, a Morton code order may be used, or a raster scan order may be used.

In addition, a plurality of vertices having coincident coordinates, that is, duplicate vertices may be collectively rearranged in a predetermined order as a single vertex.

The mesh buffer unit 202C is configured to accumulate coordinates and connection information of vertices of the I frame decoded by the intra decoding unit 202B.

The connection information decoding unit 202D is configured to set the connection information of the I frame extracted from mesh buffer unit 202C as the connection information of the P frame.

The inter decoding unit 202E is configured to decode the coordinates of the vertices of the P frame by adding the coordinates of the vertices of the I frame extracted from the mesh buffer unit 202C and the motion vector decoded from the bit stream of the P frame.

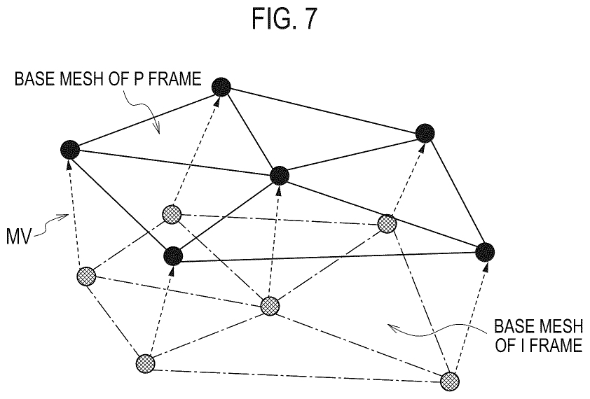

In the present embodiment, as illustrated in FIG. 7, there is a correspondence between the vertices of the base mesh of the P frame and the vertices of the base mesh of the I frame (reference frame). Here, the motion vector decoded by the inter decoding unit 202E is a difference vector between the coordinates of the vertex of the base mesh of the P frame and the coordinates of the vertex of the base mesh of the I frame.

### (Inter Decoding Unit 202E)

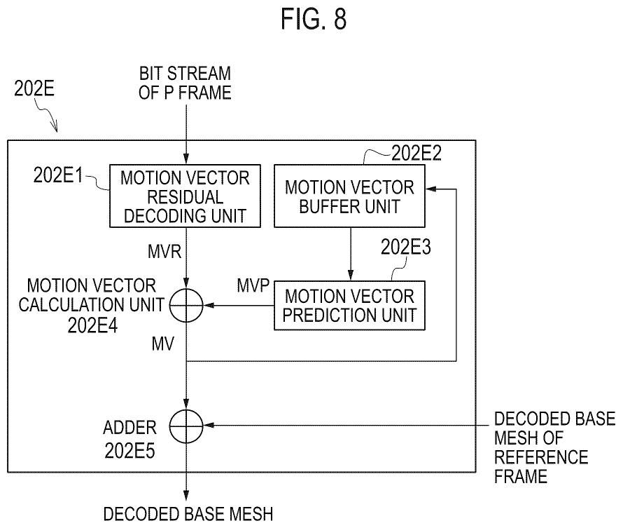

FIG. 8 is a diagram illustrating an example of functional blocks of the inter decoding unit 202E.

As illustrated in FIG. 8, the inter decoding unit 202E includes a motion vector residual decoding unit 202E1, a motion vector buffer unit 202E2, a motion vector prediction unit 202E3, a motion vector calculation unit 202E4, and an adder 202E5.

The motion vector residual decoding unit 202E1 is configured to generate a motion vector residual (MVR) from a P-frame bit stream.

Here, the MVR is a motion vector residual indicating a difference between a motion vector (MV) and a motion vector prediction (MVP). The MV is a difference vector (motion vector) between the coordinates of the vertex of the corresponding I frame and the coordinates of the vertex of the P frame. The MVP is a predicted value of the MV of a target vertex using the MV (a predicted value of a motion vector).

The motion vector buffer unit 202E2 is configured to sequentially store the MVs output by the motion vector calculation unit 202E4.

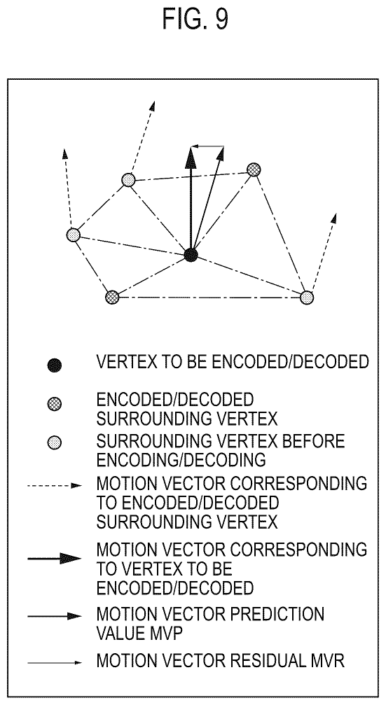

The motion vector prediction unit 202E3 is configured to acquire the decoded MV from the motion vector buffer unit 202E2 for the vertex connected to the vertex to be decoded, and output the MVP of the vertex to be decoded using all or some of the acquired decoded MVs as illustrated in FIG. 9.

The motion vector calculation unit 202E4 is configured to add the MVR generated by the motion vector residual decoding unit 202E1 and the MVP output from the motion vector prediction unit 202E3, and output the MV of the vertex to be decoded.

The adder 202E5 is configured to add the coordinates of the vertex corresponding to the vertex to be decoded obtained from the decoded base mesh of the I frame (reference frame) having the correspondence and the motion vector MV output from the motion vector calculation unit 202E4, and output the coordinates of the vertex to be decoded.

Details of each unit of the inter decoding unit 202E will be described below.

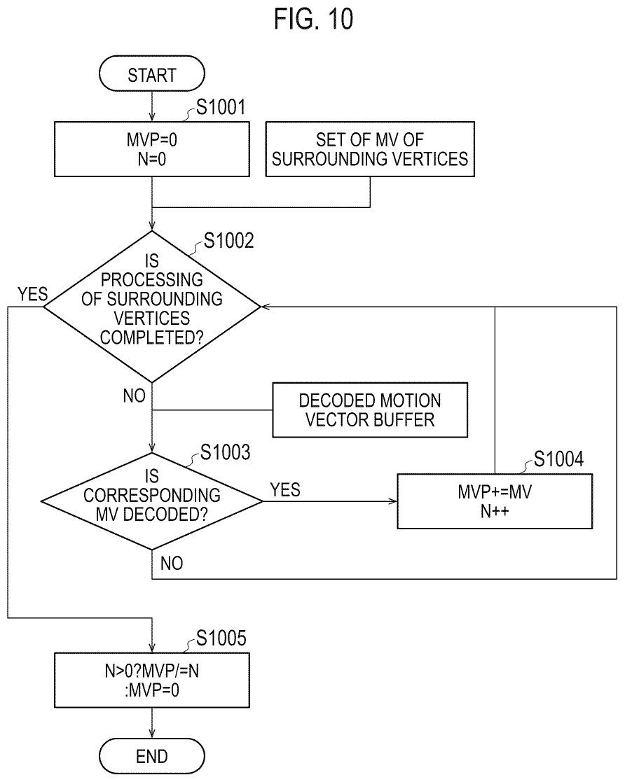

FIG. 10 is a flowchart illustrating an example of the operation of the motion vector prediction unit 202E3.

As illustrated in FIG. 10, in step S1001, the motion vector prediction unit 202E3 sets the MVP and N to 0.

In step S1002, the motion vector prediction unit 202E3 acquires a set of MVs of vertices around the vertex to be decoded from the motion vector buffer unit 202E2, specifies a vertex for which subsequent processing has not been completed, and transitions to No. In a case where the subsequent processing has been completed for all vertices, the motion vector prediction unit 202E3 transitions to Yes.

In step S1003, the motion vector prediction unit 202E3 transitions to No if the MV of the vertex to be processed has not been decoded, and transitions to Yes if the MV of the vertex to be processed has been decoded.

In step S1004, the motion vector prediction unit 202E3 adds the MV to the MVP and adds 1 to N.

In step S1005, the motion vector prediction unit 202E3 outputs a result obtained by dividing the MVP by N when N is larger than 0, outputs 0 when N is 0, and ends the processing.

That is, the motion vector prediction unit 202E3 is configured to output the MVP to be decoded by averaging the decoded motion vectors of the vertices around the vertex to be decoded.

Note that the motion vector prediction unit 202E3 may be configured to set the MVP to 0 in a case where the set of decoded motion vectors is an empty set.

The motion vector calculation unit 202E4 may be configured to calculate the MV of the vertex to be decoded from the MVP output by the motion vector prediction unit 202E3 and the MVR generated by the motion vector residual decoding unit 202E1 according to Expression (1).

$$MV ( k ) = MVP ( k ) + MVR ( k ) \qquad ( 1 )$$

Here, k is an index of a vertex. MV, MVR, and MVP are vectors having an x component, a y component, and a z component.

According to such a configuration, since only the MVR is encoded instead of the MV using the MVP, it is possible to expect an effect of increasing the encoding efficiency.

The adder 202E5 is configured to calculate the coordinates of the vertex by adding the MV of the vertex calculated by the motion vector calculation unit 202E4 and the coordinates of the vertex of the reference frame corresponding to the vertex, and keep the connection information (connectivity) as a reference frame.

Specifically, the adder 202E5 may be configured to calculate the coordinate v′i(k) of the k-th vertex using Expression (2).

$${v}^{′} i ( k ) = {v}^{′} j ( k ) + MV ( k ) \qquad ( 2 )$$

Here, v′i(k) is a coordinate of a k-th vertex to be decoded in the frame to be decoded, v′j(k) is a coordinate of a decoded k-th vertex of the reference frame, MV(k) is a k-th MV of the frame to be decoded, and k=1, 2 . . . , K.

Further, the connection information of the frame to be decoded is made the same as the connection information of the reference frame.

Note that, since the motion vector prediction unit 202E3 calculates the MVP using the decoded MV, the decoding order affects the MVP.

The decoding order is the decoding order of the vertices of the base mesh of the reference frame. In general, in the case of a decoding method in which the number of base faces is increased one by one from an edge serving as a starting point using a constant repetition pattern, the order of vertices of the decoded base mesh is determined in the process of decoding.

For example, the motion vector prediction unit 202E3 may determine the decoding order of the vertices using Edgebreaker in the base mesh of the reference frame.

According to such a configuration, since the MV from the reference frame is encoded instead of the coordinates of the vertex, it is possible to expect an effect of increasing the encoding efficiency.

### (First Modified Example of Inter Decoding Unit 202E)

The MVP calculated in the flowchart illustrated in FIG. 10 is calculated by a simple average of the decoded surrounding MVs, but may be calculated by a weighted average.

That is, the motion vector prediction unit 202E3 may be configured to output the predicted value of the motion vector to be decoded by performing weighted averaging on the decoded motion vector of the vertex around the vertex to be decoded with a weight corresponding to the distance between the vertex to be decoded and the vertex of the reference frame corresponding to the vertex around the vertex to be decoded.

Further, the motion vector prediction unit 202E3 may be configured to output the predicted value of the motion vector to be decoded by performing weighted averaging on a part of the decoded motion vector of the vertex around the vertex to be decoded with a weight corresponding to the distance between the vertex to be decoded and the vertex of the reference frame corresponding to the vertex around the vertex to be decoded.

In the present first modified example, the motion vector prediction unit 202E3 of the inter decoding unit 202E is configured to calculate the MVP by the following procedure.

First, the motion vector prediction unit 202E3 is configured to calculate a weight.

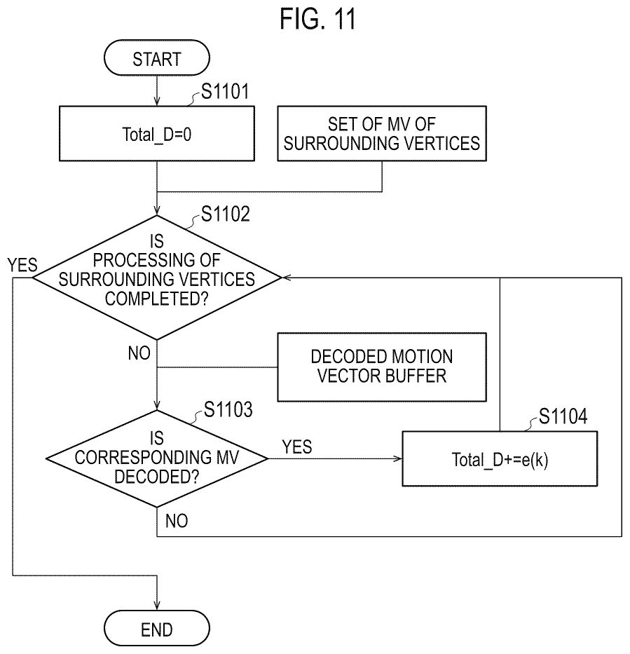

FIG. 11 is a flowchart illustrating an example of an operation of calculating a sum Total_D of distances to surrounding vertices that have been decoded.

As illustrated in FIG. 11, in step S1101, the motion vector prediction unit 202E3 sets 0 to Total_D.

Step S1102 is the same as step S1002.

Step S1103 is the same as step S1003.

In step S1104, the motion vector prediction unit 202E3 adds e(k) to Total_D.

That is, the motion vector prediction unit 202E3 refers to a set of vertices around the vertex to be decoded, and adds the distances of the decoded vertices.

In the present first modified example, the motion vector prediction unit 202E3 is configured to calculate the weight using the distance in the reference frame in which the correspondence between vertices is known.

That is, e(k) in step S1104 of FIG. 11 is a distance between corresponding vertices in the reference frame.

Then, the motion vector prediction unit 202E3 may be configured to calculate the weight w(k) by Expressions (3) and (4).

$$\begin{matrix}[ Math . 1 ] & \\ d ( k ) = \frac{Total\_D}{e ( k )} & ( 3 )\end{matrix}$$

$$w ( k ) = \frac{d ( k )}{{\sum }_{p ∈ θ} d ( p )} \qquad ( 4 )$$

Here, Θ is a set of each decoded vertex in a face of a mesh including a vertex to be decoded, e(p/k) is a distance between the vertex to be decoded and a vertex corresponding to the vertex p/k in the reference frame, and w(k) is a weight at the vertex k.

The motion vector prediction unit 202E3 may be configured to set the weight according to a rule determined in advance according to the distance.

For example, the motion vector prediction unit 202E3 may be configured to set the weight to 1 in a case where e(k) is smaller than a threshold TH1, set the weight to 0.5 in a case where e(k) is smaller than a threshold TH2, and set the weight to 0 (do not use the weight) in other cases.

According to such a configuration, it is possible to expect an effect that the MVP can be calculated with higher accuracy by increasing the weight when the distance to the vertex to be decoded is short.

Secondly, the motion vector prediction unit 202E3 is configured to refer to the MVP.

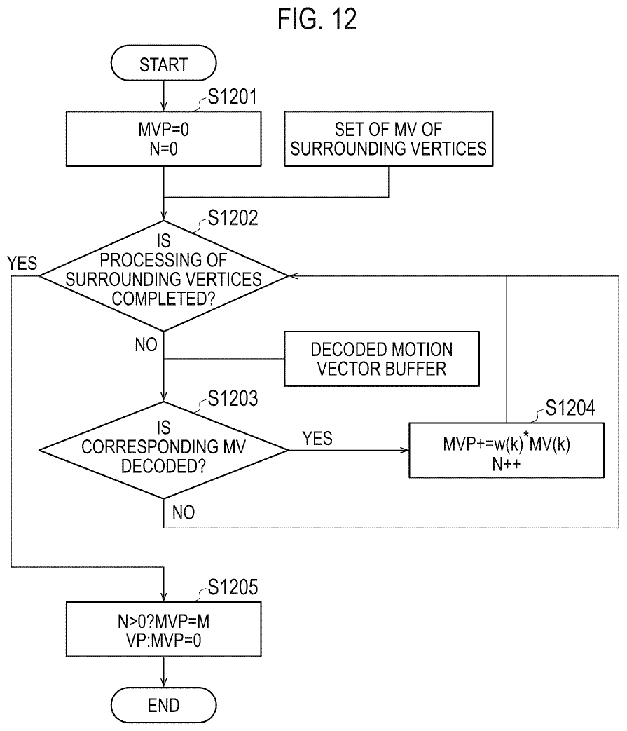

FIG. 12 is a flowchart illustrating an example of the operation of calculating the MVP using the weighted average.

As illustrated in FIG. 12, in step S1201, the motion vector prediction unit 202E3 sets the MVP and N to 0.

Step S1202 is the same as step S1002.

Step S1203 is the same as step S1003.

In step S1204, the motion vector prediction unit 202E3 adds w(k)×MV(k) to the MVP and adds 1 to N.

Step S1205 is the same as step S1005.

Alternatively, the motion vector prediction unit 202E3 may be configured to calculate the MVP by Expression (5).

$$\begin{matrix}[ Math . 2 ] & \\ MVP ( k ) = {\sum }_{m ∈ θ} w ( m ) \cdot MV ( m ) & ( 5 )\end{matrix}$$

Here, Θ is a set of each decoded vertex on the face of the mesh including the vertex to be decoded.

According to such a configuration, since the MVP with higher accuracy can be calculated by the weighted average, it is possible to expect an effect of increasing the encoding efficiency by decreasing the value of the MVR and concentrating the MVR near zero.

### (Second Modified Example of Inter Decoding Unit 202E)

In the second modified example, the motion vector prediction unit 202E3 is configured to select one MV instead of calculating the MVP using a plurality of surrounding MVs.

That is, the motion vector prediction unit 202E3 may be configured to select the MV of the nearest vertex among the decoded MVs accumulated in the motion vector buffer unit 202E2 as the MV of the vertex connected to the vertex to be decoded.

Here, the motion vector prediction unit 202E3 may be configured to construct a candidate list including MVs of vertices connected to a vertex to be decoded from among decoded MVs accumulated in the motion vector buffer unit 202E2, and select a motion vector from the candidate list on the basis of an index decoded from a bit stream of a P frame (frame to be decoded).

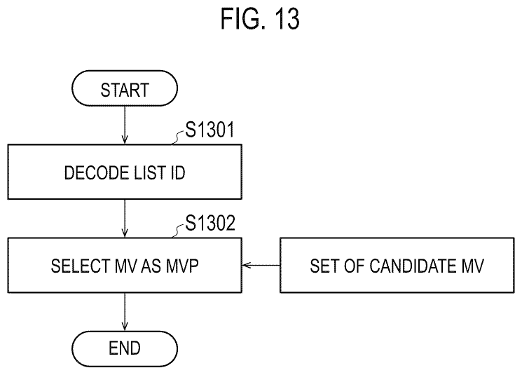

FIG. 13 is a flowchart illustrating an example of an operation of selecting an MV from a set of candidate MVs as an MVP.

As illustrated in FIG. 13, in step S1301, the motion vector prediction unit 202E3 decodes a list ID from the P-frame bit stream.

In step S1302, the motion vector prediction unit 202E3 selects an MV to which the list ID is attached as the MVP from among the candidate MVs.

Note that, in the set of candidate MVs in FIG. 13, the decoded surrounding MVs and the MVs calculated by the combination are arranged in a certain order.

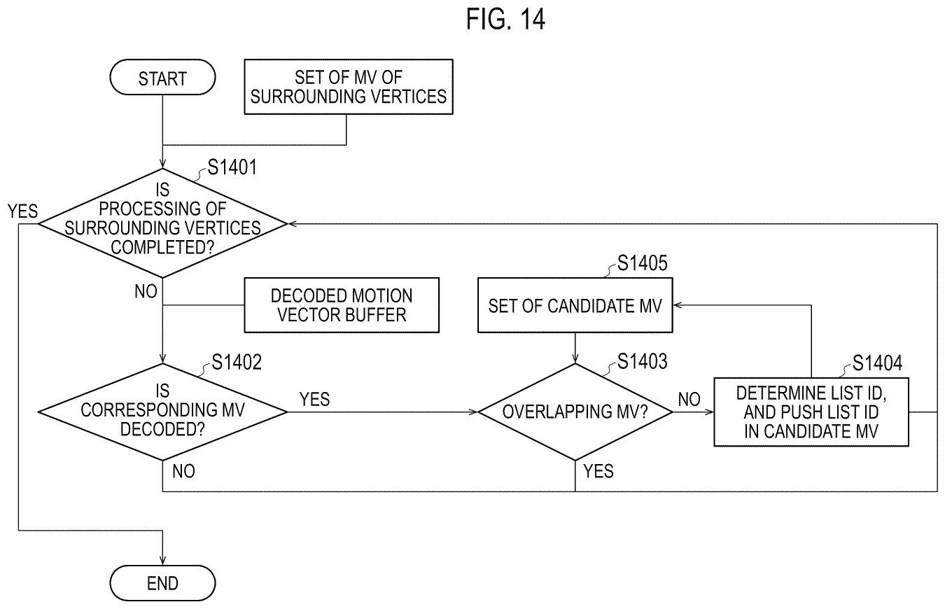

FIG. 14 is a flowchart illustrating an example of an operation of creating a set of candidate MVs.

As illustrated in FIG. 14, in step S1401, the motion vector prediction unit 202E3 refers to the set of MVs of the vertices around the vertex to be decoded, and determines whether the processing for all the vertices around the vertex to be decoded has been completed.

In a case where such processing has been completed, the present operation ends, and in a case where such processing has not been completed, the present operation proceeds to step S1402.

In step S1402, the motion vector prediction unit 202E3 determines whether the MV of the target vertex has been decoded.

In a case where the MV is decoded, the operation proceeds to step S1403, and in a case where the MV is not decoded, the operation returns to step S1401.

In step S1403, the motion vector prediction unit 202E3 determines whether the MV overlaps with another decoded MV.

In the case of overlapping, the operation returns to step S1401, and in the case of not overlapping, the operation proceeds to step S1404.

In step S1404, the motion vector prediction unit 202E3 determines a list ID to be assigned to the MV, and in step S1405, the motion vector prediction unit includes the list ID in a set of candidate MVs.

In FIG. 14, when determining the list ID, the motion vector prediction unit 202E3 may sequentially increase the list ID by one, or may determine the list ID in the order of the distance (e(k) in Expression (3)) between the vertex to be decoded and the vertex corresponding to the vertex k in the reference frame.

According to such a configuration, selecting one of the candidate MVs as the MVP may be closer to the MV than the average in some cases, and in this case, it is possible to expect an effect of increasing the encoding efficiency.

Furthermore, the motion vector prediction unit 202E3 may be configured to add an MV obtained by averaging consecutive MV0 and MV1 from the candidate MVs described above to the list as a new candidate MV. The motion vector prediction unit 202E3 adds the MV after MV0 and MV1 as illustrated in Table 1.

TABLE 1

| No (index) | Candidate MV |
|---|---|
| 0 | MV0 |
| 1 | MV1 |
| 2 | (MV0 + MV1)/2 |
| 3 | MV2 |
| 4 | MV3 |

According to such a configuration, it is possible to expect an effect of increasing the possibility that the selected candidate MV is closer to the MV of the vertex to be decoded.

Furthermore, the motion vector prediction unit 202E3 may be configured to select the MV of the closest vertex from the set of candidate MVs without encoding the list ID. According to such a configuration, it is possible to expect an effect of further increasing the encoding efficiency.

### (Third Modified Example of Inter Decoding Unit 202E)

In the above-described embodiment and first and second modified examples, the surrounding vertices are vertices connected to the vertex to be decoded.

On the other hand, in the present third modified example, the motion vector prediction unit 202E3 is configured to calculate the MVP by parallelogram prediction, that is, by also using a vertex that is not directly connected to a vertex to be decoded.

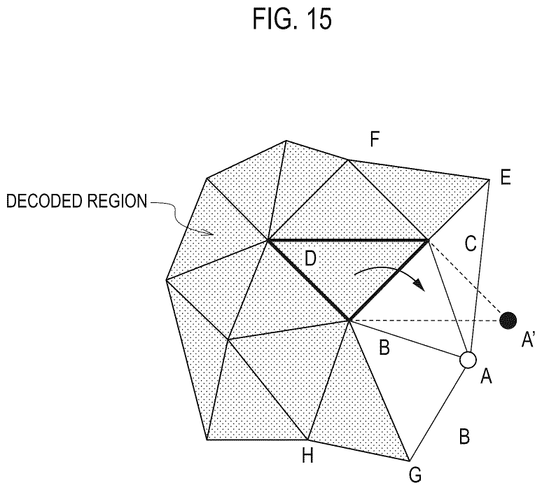

As illustrated in FIG. 15, in parallelogram prediction, a vertex D on the opposite side of a decoded face having a vertex A to be decoded and a shared edge BC is also used.

Furthermore, the shared edge of the vertex A to be decoded includes CE and BG in addition to AB. Thus, vertices F and H are likewise available in parallelogram prediction.

For example, the motion vector prediction unit 202E3 may be configured to calculate MVP by Expression (6) using the face BCD illustrated in FIG. 15.

$$MVP = MV ( B ) + MV ( C ) - MV ( D ) \qquad ( 6 )$$

Here, MV(X) is a motion vector of the vertex X, and MVP is a motion vector prediction value of the vertex A to be decoded.

In addition, when there are a plurality of shared edges described above, the motion vector prediction unit 202E3 may average the respective MVPs, or may select a face having the closest center of gravity of the face.

### (Fourth Modified Example of Inter Decoding Unit 202E)

In the present modified example, the MVR generated by the motion vector residual decoding unit 202E1 is not maintained as it is, and the quantized width when the MVR is expressed as an integer is controlled.

In the present modified example, the motion vector residual decoding unit 202E1 is configured to decode adaptive_mesh_flag, adaptive_bit_flag, and the accuracy control parameter as control information for controlling the quantized width of the MVR.

That is, the motion vector residual decoding unit 202E1 is configured to decode adaptive_mesh_flag of the entire base mesh and adaptive_bit_flag for each meshpatch.

Here, adaptive_mesh_flag and adaptive_bit_flag are flags indicating whether to adjust the quantized width of the MVR described above, and take either a value of 0 or 1.

Here, the motion vector residual decoding unit 202E1 decodes adaptive_bit_flag only in a case where adaptive_mesh_flag is valid (that is, 1).

Furthermore, in a case where adaptive_mesh_flag is invalid (that is, 0), the motion vector residual decoding unit 202E1 considers that adaptive_bit_flag is invalid (that is, 0).

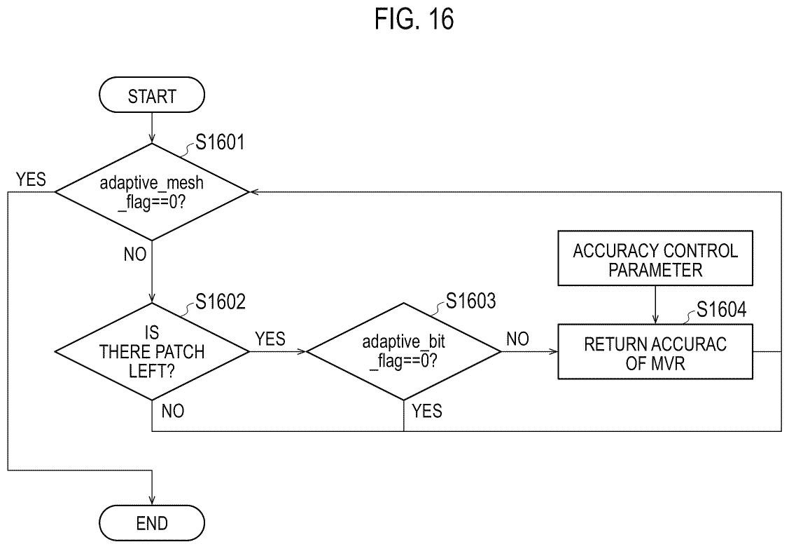

FIG. 16 is a flowchart illustrating an example of an operation of controlling the quantized width of the decoded MVR from adaptive_mesh_flag, adaptive_bit_flag, and the accuracy control parameter which are control information generated by decoding the base mesh bit stream.

As illustrated in FIG. 16, in step S1601, the motion vector prediction unit 202E3 determines whether adaptive_mesh_flag is 0.

In a case where it is determined that adaptive_mesh_flag of the entire mesh is 0, this operation ends.

On the other hand, in a case where it is determined that adaptive_mesh_flag of the entire mesh is 1, the present operation proceeds to step S1602.

In step S1602, the motion vector prediction unit 202E3 determines whether there is an unprocessed patch in the frame.

In step S1603, the motion vector prediction unit 202E3 determines whether adaptive_mesh_flag decoded for each patch is 0.

In a case where adaptive_mesh_flag is determined to be 0, the present operation returns to step S1601.

On the other hand, in a case where adaptive_mesh_flag is determined to be 1, the present operation proceeds to step S1604.

In step S1604, the motion vector prediction unit 202E3 controls the quantized width of the MVR on the basis of an accuracy control parameter to be described later.

Note that the value of MVR in which the quantized width is controlled in this manner is referred to as “Motion Vector Residual Quantization (MVRQ)”.

Here, the motion vector prediction unit 202E3 may be configured to use the quantized width of the MVR corresponding to the quantized width control parameter generated by the base mesh bit stream decoding with reference to, for example, a table as shown in Table 2.

TABLE 2

| Quantized width | Quantized width |
|---|---|
| control parameter | of MVR |
| 1 | Two times |
| 2 | Four times |
| 3 | Eight times |

According to such a configuration, it is possible to expect an effect that the encoding efficiency can be enhanced by controlling the quantized width of the MVR. Furthermore, by the hierarchical mechanism of the mesh-level adaptive_mesh_flag and the patch-level adaptive_mesh_flag, it is possible to expect an effect that useless bits can be minimized when the quantized width of the MVR is not controlled.

### (Fifth Modified Example of Inter Decoding Unit 202E)

In a case where the MVR generated by the motion vector residual decoding unit 202E1 is not encoded, an error occurs. In the fifth modified example, in order to correct such an error, a discrete motion vector difference is encoded.

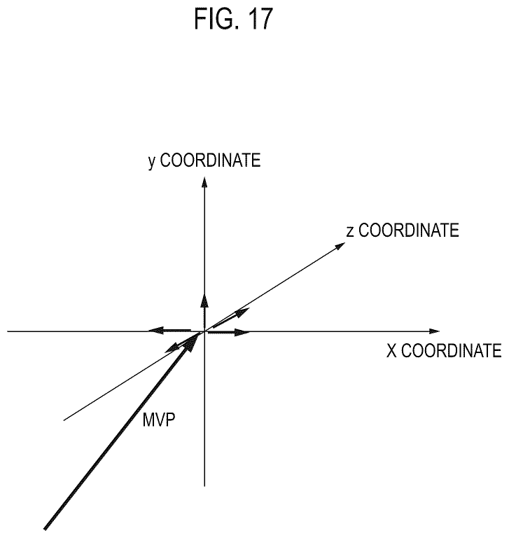

Specifically, as illustrated in FIG. 17, the MVR can take the sizes of 1, 2, 4, and 8 in six directions of the x axis, the y axis, and the z axis. An example of such encoding is shown in Tables 3 and 4.

Furthermore, MVR encoding may be performed in combination of a plurality of directions. For example, the correction may be performed in the order of 2 in the +direction of the x axis and 1 in the +direction of the y axis.

TABLE 3

| | | | | | | |
|---|---|---|---|---|---|---|
| direction_idx | 000 | 001 | 010 | 011 | 100 | 101 |

TABLE 4

| | | | | |
|---|---|---|---|---|
| distance_idx | 0 | 1 | 2 | 3 |
| value | | 2 | 4 | 8 |

According to such a configuration, it is possible to expect an effect that the encoding efficiency of the discrete motion vector difference is higher than that of the MVR encoding.

A further modified example of the inter decoding unit 202E will be described below.

In a further modified example of the above-described inter decoding unit 202E, the following functional blocks are added before the above-described inter decoding unit 202E is implemented.

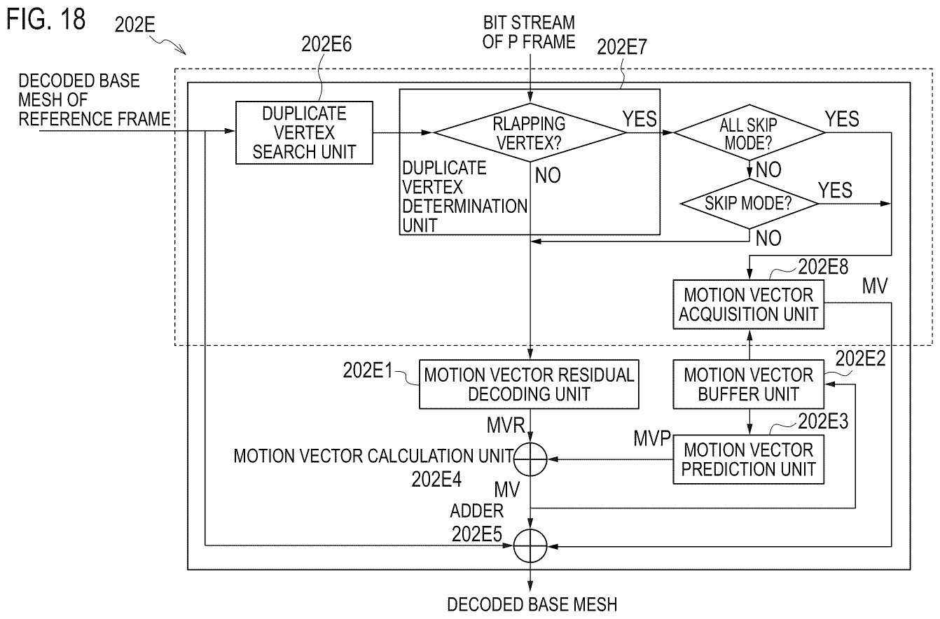

Specifically, as illustrated in FIG. 18, the inter decoding unit 202E includes a duplicate vertex search unit 202E6, a duplicate vertex determination unit 202E7, a motion vector acquisition unit 202E8, an A11 skip mode signal, and a skip mode signal, in addition to the configuration illustrated in FIG. 8.

Here, the A11 skip mode signal is at the beginning of the bit stream of the P frame, has at least two values, and is one bit or one or more bits.

One case (in a case where the A11 skip mode signal indicates Yes, for example, when it is 1) is a signal for copying the motion vectors of the duplicate vertices without decoding the motion vectors of all the duplicate vertices of the P frame from the bit stream.

The other case (in a case where the A11 skip mode signal indicates No, for example, when it is 0) is a signal that performs different processing at each vertex of the P frame. Furthermore, the another one may have other values. For example, the other case is a signal in which the motion vector acquisition unit 202E8 performs the processing similar to that of the inter decoding unit 202E illustrated in FIG. 8 without performing the processing on the motion vectors of all the duplicate vertices but.

Here, in a case where the A11 skip mode signal indicates No, the Skip mode signal has two values for each duplicate vertex and is one bit.

The Skip mode signal is a signal for copying the motion vector of the duplicate vertex without decoding the motion vector of the vertex from the bit stream in a case where the A11 skip mode signal indicates Yes (for example, in the case of 1).

The Skip mode signal is a signal for performing the processing similar to that of the inter decoding unit 202E illustrated in FIG. 8 without performing the processing in the motion vector acquisition unit 202E8 for the motion vector of the vertex in a case where the A11 skip mode signal indicates No (for example, in the case of 0).

Note that the above-described Skip mode signal may be directly decoded from the bit stream, or data (for example, the index of the duplicate vertex) specifying duplicate vertices for which processing similar to that of the inter decoding unit 202E illustrated in FIG. 8 is performed may be decoded from the bit stream, and the Skip mode signal may be calculated from the data.

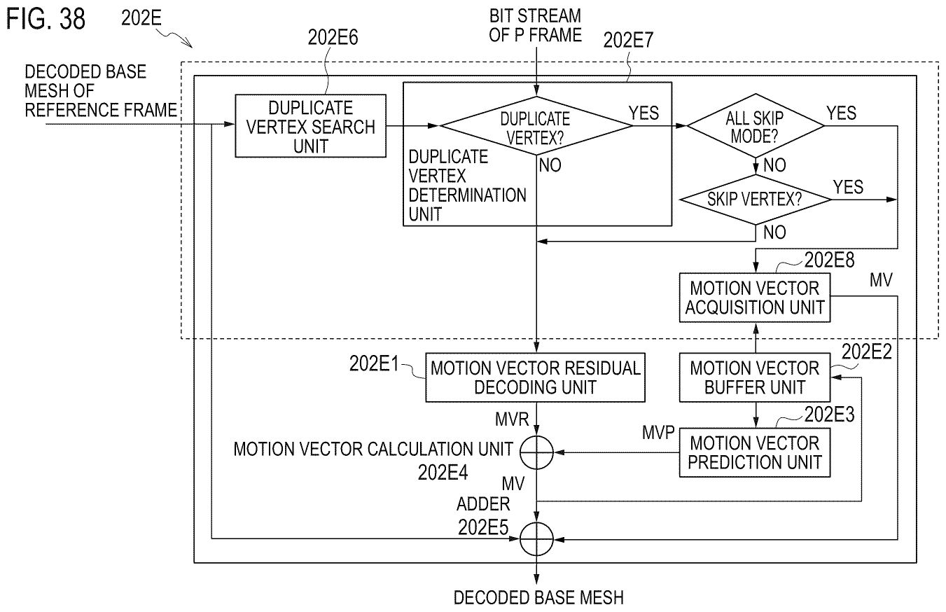

Furthermore, as illustrated in FIG. 38, the motion vector decoding method for the vertex may be determined similarly to the case described above by using the data (for example, the index of the duplicate vertex) that specifies the duplicate vertex for which the processing similar to that of the inter decoding unit 202E illustrated in FIG. 8 is performed without calculating the Skip mode signal.

The duplicate vertex search unit 202E6 is configured to search for an index of a vertex (hereinafter, referred to as a duplicate vertex) whose coordinates match from the geometric information of the base mesh of the decoded reference frame and store the index in a buffer (not illustrated).

Specifically, the inputs of the duplicate vertex search unit 202E6 are an index (decoding order) and position coordinates of each vertex of the base mesh of the decoded reference frame.

Furthermore, the output of the duplicate vertex search unit 202E6 is a list of a pair of the index (vindex0) of the vertex where the duplicate vertex exists and the index (vindex1) of the duplicate vertex. Here, the list of such pairs is stored in a buffer repVert in the order of index0.

In addition, since the vertex of vindex1 has been decoded before vindex0, a relationship of vindex0>vindex1 is established.

As a method for finding duplicate vertices in the base mesh of the reference frame, not position coordinates but indexes of duplicate vertices are decoded by a special signal with respect to vertices where the duplicate vertices exist. By such a special signal, a pair of the index of the corresponding vertex and the index of the duplicate vertex can be stored in decoding order.

The duplicate vertex determination unit 202E7 is configured to determine whether there is a duplicate vertex among the vertices decoded by the corresponding vertex.

Here, if the index of the corresponding vertex is among the indexes of the vertices where the duplicate vertex exists, the duplicate vertex determination unit 202E7 determines that there is the duplicate vertex in the decoded vertices. Note that, since the corresponding vertex comes in the decoding order, the above-described search is unnecessary.

Here, in a case where the duplicate vertex determination unit 202E7 determines that there is no duplicate vertex of the corresponding vertex, processing similar to that of the inter decoding unit 202E illustrated in FIG. 8 is performed.

In a case where the duplicate vertex of the corresponding vertex exists, the motion vector acquisition unit 202E8 is configured to acquire a motion vector of a vertex having the same index as that of the duplicate vertex from the motion vector buffer unit 202E2 that stores the decoded motion vector and set the motion vector as the motion vector of the corresponding vertex in a case where the A11 skip mode signal indicates Yes or in a case where the A11 skip mode signal indicates No and a case where the Skip mode signal indicates Yes.

Here, in a case where the A11 skip mode signal indicates No and the Skip mode signal of the vertex indicates No, processing similar to that of the inter decoding unit 202E illustrated in FIG. 8 is performed instead of the motion vector acquisition unit 202E8.

According to such a configuration, with respect to the vertex where the duplicate vertex exists, it is possible to expect an effect of decoding calculation of motion vectors and reduction of the code amount.

In the above-described further modified example of the inter decoding unit 202E, the inter decoding unit 202E acquires the correspondence between the vertex of the reference frame and the vertex of the frame to be decoded from the decoded base mesh of the reference frame.

Then, the inter decoding unit 202E is configured not to encode the connection information of the vertex of the frame to be decoded on the basis of the correspondence and to make the connection information identical to the connection information of the decoded vertex of the reference frame.

Furthermore, the inter decoding unit 202E divides the base mesh of the frame to be decoded into two types of regions on the basis of signals in the decoding order of the vertices of the reference frame. In a first region, decoding is performed using inter processing, and in a second region, decoding is performed using intra processing.

Note that the above-described region is defined as a region formed by a plurality of vertices continuous in the decoding order when the base mesh of the reference frame is decoded.

In addition, the following two implementations are assumed as means for decoding the coordinates of the vertex of the base mesh of the frame to be decoded using a signal.

### (Means 1)

In means 1, the signals are vertex_idx1, vertex_idx2 and intra_flag.

Here, vertex_idx1 and vertex_idx2 are indexes (vertex indexes) of decoding order of vertices, and intra_flag is a flag indicating whether an inter decoding technique or an intra decoding technique is used. There may be a plurality of such signals.

That is, vertex_idx1 and vertex_idx2 are vertex indices that define the start position and the end position of the above-described partial region (the first region and the second region).

### (Means 2)

In means 2, there is a premise that the connection information of the base mesh of the reference frame is decoded by Edgebreaker, and the decoding order of the coordinates of the vertices is set to the order determined by Edgebreaker.

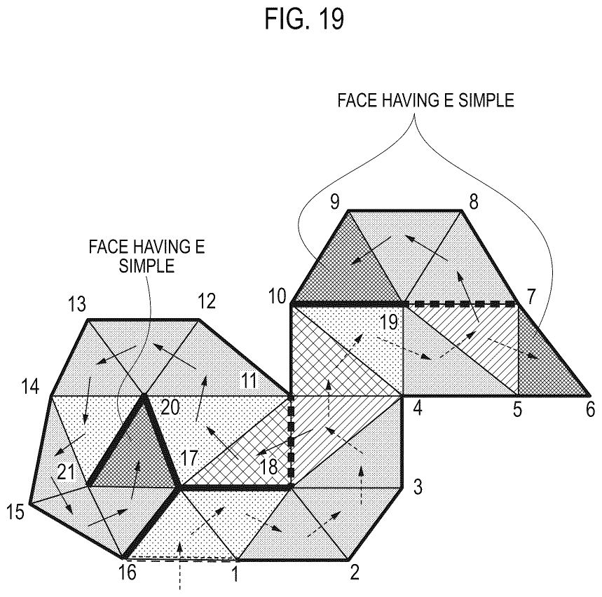

FIG. 19 is a diagram illustrating an example of an operation of determining connection information and an order of vertices using Edgebreaker.

In FIG. 19, arrows indicate the decoding order of the connection information, a number indicates the decoding order of the vertex, and the same region is defined by an arrow of the same line type.

In means 2, the signal is only intra_flag which is a flag indicating whether it is an inter decoding technique or an intra decoding technique.

That is, in means 2, the inter decoding unit 202E is configured to divide the region into the first region and the second region using Edgebreaker.

### <Subdivision Unit 203>

The subdivision unit 203 is configured to generate and output the added subdivided vertices and their connection information from the base mesh decoded by the base mesh decoding unit 202 by the subdivision method indicated by the control information.

Here, the base mesh, the added subdivided vertex, and the connection information thereof are collectively referred to as a “subdivided mesh”.

The subdivision unit 203 is configured to specify the type of the subdivision method from division_method_id which is control information generated by decoding the base mesh bit stream.

Hereinafter, the subdivision unit 203 will be described with reference to FIGS. 3A and 3B.

FIGS. 3A and 3B are diagrams for explaining an example of an operation of generating a subdivided vertex from a base mesh.

FIG. 3A is a diagram illustrating an example of a base mesh including five vertices.

Here, for the subdivision, for example, a mid-edge subdivision division method of connecting midpoints of edges in each base face may be used. As a result, a certain base face is divided into four faces.

FIG. 3B illustrates an example of a subdivided mesh obtained by dividing a base mesh including five vertices. In the subdivided mesh illustrated in FIG. 3B, eight subdivided vertices (white circles) are generated in addition to the original five vertices (black circles).

By decoding the displacement by the displacement decoding unit 206 for each subdivided vertex generated in this manner, improvement in encoding performance can be expected.

In addition, a different subdivision method may be applied to each patch. Therefore, the displacement decoded by the displacement decoding unit 206 is adaptively changed in each patch, and the improvement of the encoding performance can be expected. The divided patch information is received as patch_id that is control information.

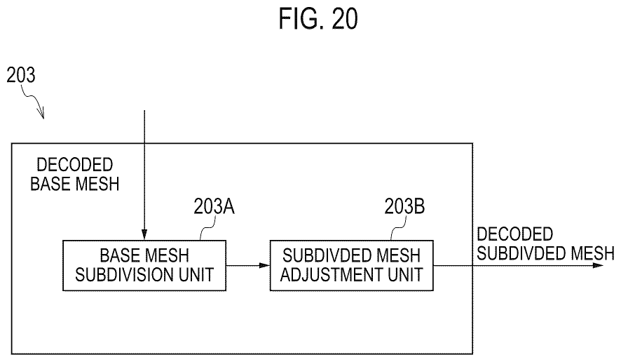

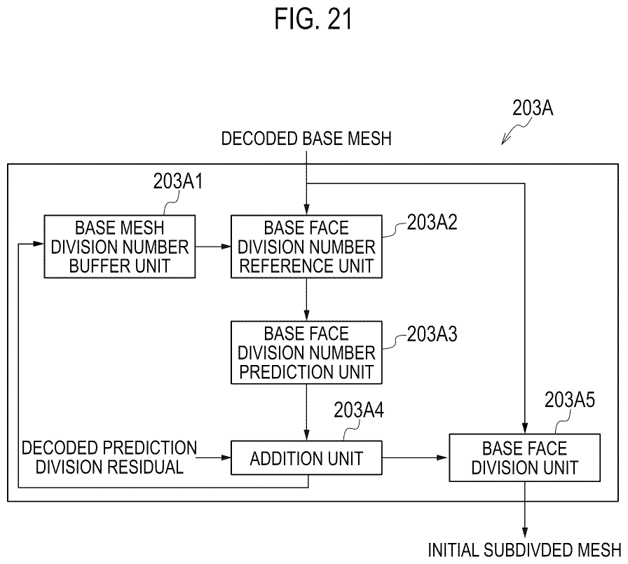

Hereinafter, the subdivision unit 203 will be described with reference to FIG. 20. FIG. 21 is a diagram illustrating an example of functional blocks of the subdivision unit 203.

As illustrated in FIG. 21, the subdivision unit 203 includes a base mesh subdivision unit 203A and a subdivided mesh adjustment unit 203B.

### (Base Mesh Subdivision Unit 203A)

The base mesh subdivision unit 203A is configured to calculate the number of divisions (the number of subdivisions) for each of the base face and the meshpatch on the basis of the input base mesh and the division information of the base mesh, subdivide the base mesh on the basis of the number of divisions, and output the subdivided face.

That is, the base mesh subdivision unit 203A may be configured such that the above-described number of divisions can be changed in units of base faces and meshpatches.

Here, the base face is a face constituting the base mesh, and the meshpatch is a set of several base faces.

Furthermore, the base mesh subdivision unit 203A may be configured to predict the number of subdivisions of the base face, and calculate the number of subdivisions of the base face by adding a prediction division number residual to the predicted number of subdivisions of the base face.

Furthermore, the base mesh subdivision unit 203A may be configured to calculate the number of subdivisions of the base face on the basis of the number of subdivisions of an adjacent base face of the base face.

Furthermore, the base mesh subdivision unit 203A may be configured to calculate the number of subdivisions of the base face based on the number of subdivisions of the base face accumulated immediately before.

Furthermore, the base mesh subdivision unit 203A may be configured to generate vertices that divide three edges constituting the base face, and subdivide the base face by connecting the generated vertices.

As illustrated in FIG. 20, the subdivided mesh adjustment unit 203B to be described later is provided at a subsequent stage of the base mesh subdivision unit 203A.

Hereinafter, an example of processing of the base mesh subdivision unit 203A will be described with reference to FIGS. 21 to 23.

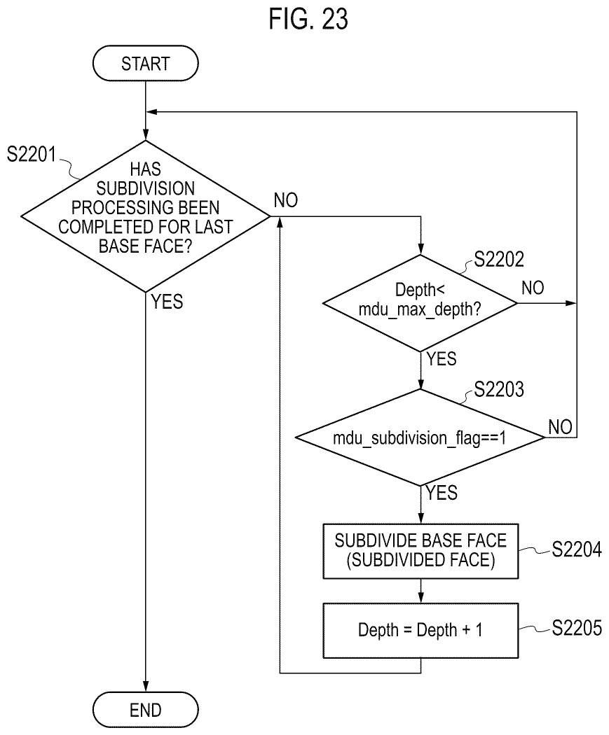

FIG. 21 is a diagram illustrating an example of functional blocks of the base mesh subdivision unit 203A, and FIG. 23 is a flowchart illustrating an example of operation of the base mesh subdivision unit 203A.

As illustrated in FIG. 21, the base mesh subdivision unit 203A includes a base face division number buffer unit 203A1, a base face division number reference unit 203A2, a base face division number prediction unit 203A3, an addition unit 203A4, and a base face division unit 203A5.

The base face division number buffer unit 203A1 stores division information of the base face including the number of divisions of the base face, and is configured to output the division information of the base face to the base face division number reference unit 203A2.

Here, the size of the base face division number buffer unit 203A1 may be set to 1, and the number of divisions of the base face accumulated immediately before may be output to the base face division number reference unit 203A2.

That is, by setting the size of the base face division number buffer unit 203A1 to 1, only the number of last decoded subdivisions (the number of subdivisions decoded immediately before) may be referred to.

In a case where the base face adjacent to the base face to be decoded does not exist, or in a case where the base face adjacent to the base face to be decoded exists but the number of divisions is not fixed, the base face division number reference unit 203A2 is configured to output “reference impossible” to the base face division number prediction unit 203A3.

On the other hand, the base face division number reference unit 203A2 is configured to output the number of divisions to the base face division number prediction unit 203A3 in a case where the base face adjacent to the base face to be decoded exists and the number of divisions is determined.

The base face division number prediction unit 203A3 is configured to predict the number of divisions (the number of subdivisions) of the base face on the basis of the one or more input numbers of division, and output the predicted number of division (prediction division number) to the addition unit 203A4.

Here, the base face division number prediction unit 203A3 is configured to output 0 to the addition unit 203A4 in a case where only “reference impossible” is input from the base face division number reference unit 203A2.

Note that, in a case where one or more numbers of division are input, the base face division number prediction unit 203A3 may be configured to generate the prediction division number by using any one of statistical values such as an average value, a maximum value, a minimum value, and a mode value of the input number of divisions.

Note that the base face division number prediction unit 203A3 may be configured to generate the number of divisions of the most adjacent face as the prediction division number when one or more numbers of divisions are input.

The addition unit 203A4 is configured to output the number of divisions obtained by adding the prediction division number residual decoded from the prediction residual bit stream and the prediction division number acquired from the base face division number prediction unit 203A3 to the base face division unit 203A5.

The base face division unit 203A5 is configured to subdivide the base face on the basis of the input number of divisions from the addition unit 203A4.

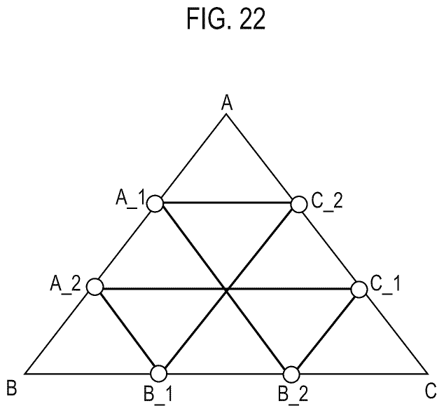

FIG. 22 illustrates an example of a case where the base face is divided into nine. A method of dividing the base face by the base face division unit 203A5 will be described with reference to FIG. 22.

The base face division unit 203A5 generates points A_1, . . . , and A_(N−1) equally dividing the edge AB constituting the base face into N (N=3).

Similarly, the base face division unit 203A5 equally divides the edge BC and the edge CA into N, and generates points B_1, . . . , B_(N−1), C_1, . . . , and C_(N−1), respectively.

Hereinafter, points on the edge AB, the edge BC, and the edge CA are referred to as “edge division points”.

The base face division unit 203A5 generates edges A_i B_(N−i), B_i C_(N−i), and C_i_A_(N−i) for all i (i=1, 2, . . . , N−1), and generates N2 subdivided faces.

Next, a processing procedure of the base mesh subdivision unit 203A will be described with reference to FIG. 23.

In step S2201, it is determined whether the subdivision processing has been completed for the last base face. In a case where the processing is completed, the process ends, and if not, the process proceeds to step S2202.

In step S2202, the base mesh subdivision unit 203A determines Depth<mdu_max_depth.

Here, Depth is a variable representing the current depth, the initial value is 0, and mdu_max_depth represents the maximum depth determined for each base face.

In a case where the condition in step S2202 is satisfied, the processing procedure proceeds to step S2203, and in a case where the condition is not satisfied, the processing procedure returns to step S2201.

In step S2203, the base mesh subdivision unit 203A determines whether mdu_division_flag at the current depth is 1.

In the case of Yes, the processing procedure proceeds to step S2201, and in the case of No, the processing procedure proceeds to step S2204.

In step S2204, the base mesh subdivision unit 203A further subdivides all the subdivided faces in the base face.

Here, the base mesh subdivision unit 203A subdivides the base face in a case where the subdivision processing has never been performed on the base face.

Note that the method of subdivision is similar to the method described in step S2204.

Specifically, in a case where the base face has never been subdivided, the base face is subdivided as illustrated in FIG. 22. In a case where subdivision has been performed at least once, the subdivided face is subdivided into N2. In the example of FIG. 22, the face including the vertex A_2, the vertex B, and the vertex B_1 is further divided by the same method as in the division of the base face to generate N2 faces.

When the subdivision processing ends, the processing procedure proceeds to step S2205.

In step S2205, the base mesh subdivision unit 203A adds 1 to Depth, and the present processing procedure returns to step S2202.

### (Subdivided Mesh Adjustment Unit 203B)

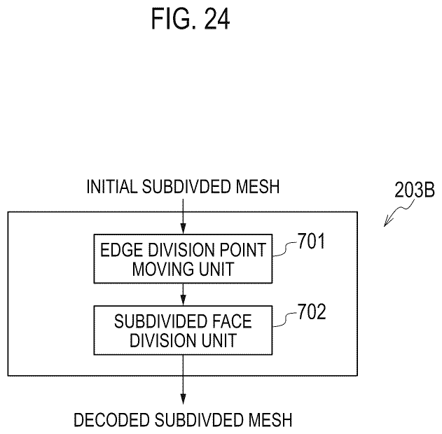

Next, a specific example of processing performed by the subdivided mesh adjustment unit 203B will be described. Hereinafter, an example of processing performed by the subdivided mesh adjustment unit 203B will be described with reference to FIGS. 24 to 28.

FIG. 24 is a diagram illustrating an example of functional blocks of the subdivided mesh adjustment unit 203B.

As illustrated in FIG. 24, the subdivided mesh adjustment unit 203B includes an edge division point moving unit 701 and a subdivided face division unit 702.

### (Edge Division Point Moving Unit 701)

The edge division point moving unit 701 is configured to move the edge division point of the base face to any one of the edge division points of the adjacent base faces with respect to the input initial subdivided face, and output the subdivided face.

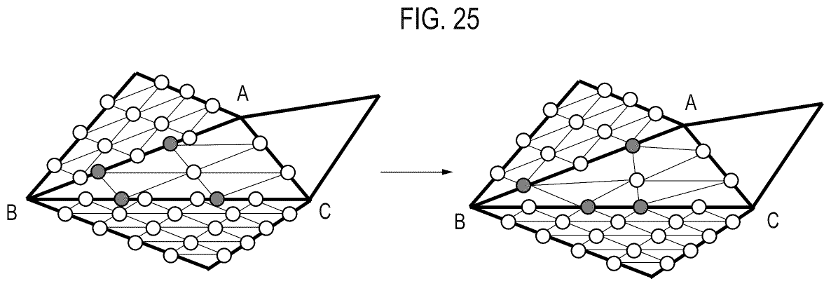

FIG. 25 illustrates an example in which the edge division point on a base face ABC is moved. For example, as illustrated in FIG. 25, the edge division point moving unit 701 may be configured to move the edge division point of the base face ABC to the edge division point of the closest adjacent base face.

### (Subdivided Face Division Unit 702)

The subdivided face division unit 702 is configured to subdivide the input subdivided face again and output the decoding subdivided face.

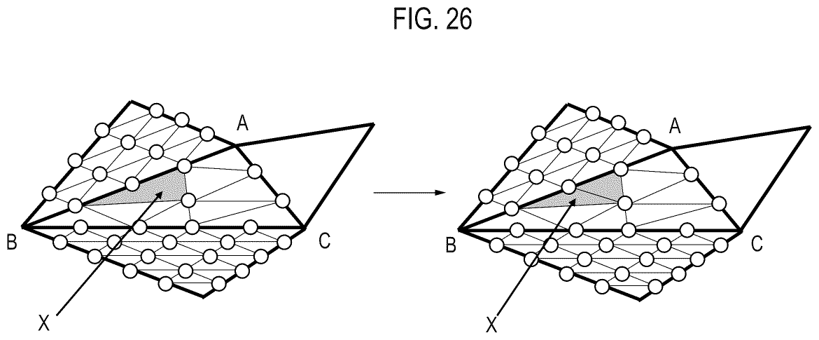

FIG. 26 is a diagram illustrating an example of a case where a subdivided face X in the base face is subdivided again.

As illustrated in FIG. 26, the subdivided face division unit 702 may be configured to generate a new subdivided face in the base face by connecting a vertex constituting the subdivided face and an edge division point of the adjacent base face.

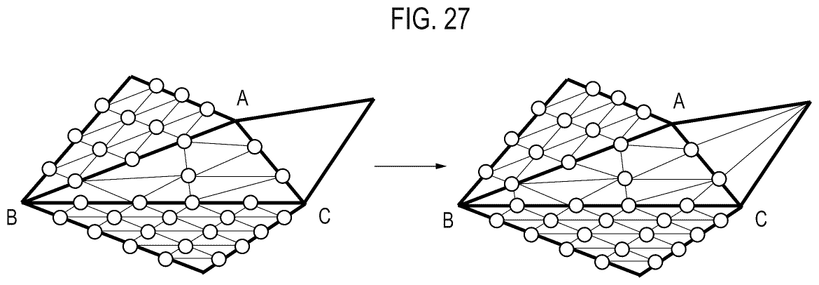

FIG. 27 is a diagram illustrating an example of a case where the above-described subdivision processing is performed on all the subdivided faces.

The mesh decoding unit 204 is configured to generate and output a decoded mesh using the subdivided mesh generated by the subdivision unit 203 and the displacement decoded by the displacement decoding unit 206.

Specifically, the mesh decoding unit 204 is configured to generate a decoded mesh by adding a corresponding displacement to each subdivided vertex. Here, information on which subdivided vertex each displacement corresponds is indicated by the control information.

The patch integration unit 205 is configured to integrate and output the plurality of patches of the decoded mesh generated by the mesh decoding unit 204.

Here, a patch division method is defined by the mesh encoding device 100. For example, the patch division method may be configured such that a normal vector is calculated for each base face, a base face having the most similar normal vector among adjacent base faces is selected, both base faces are grouped as the same patch, and such a procedure is sequentially repeated for the next base face.

The video decoding unit 207 is configured to decode and output texture by video coding. For example, the video decoding unit 207 may use HEVC described in Reference 1.

### <Displacement Decoding Unit 206>

The displacement decoding unit 206 is configured to decode a displacement bit stream to generate and output a displacement.

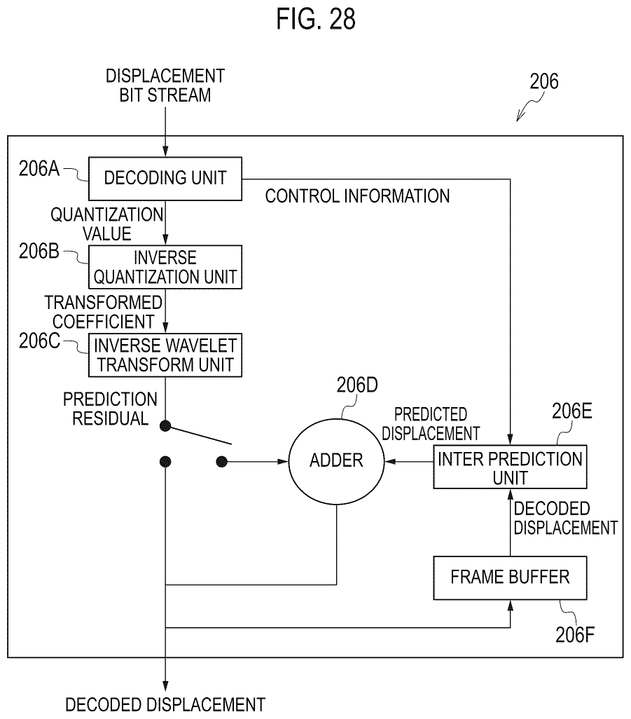

FIG. 28 is a diagram illustrating an example of a displacement with respect to a certain subdivided vertex.

In the example of FIG. 3B, since there are eight subdivided vertices, the displacement decoding unit 206 is configured to define eight displacements expressed by scalars or vectors for each subdivided vertex.

The displacement decoding unit 206 will be described below with reference to FIG. 28. FIG. 28 is a diagram illustrating an example of functional blocks of the displacement decoding unit 206.

As illustrated in FIG. 28, the displacement decoding unit 206 includes a decoding unit 206A, an inverse quantization unit 206B, an inverse wavelet transform unit 206C, an adder 206D, an inter prediction unit 206E, and a frame buffer 206F.

The decoding unit 206A is configured to decode and output the level value and the control information by performing variable-length decoding on the received displacement bit stream. Here, the level value obtained by the variable-length decoding is output to the inverse quantization unit 206B, and the control information is output to the inter prediction unit 206E.

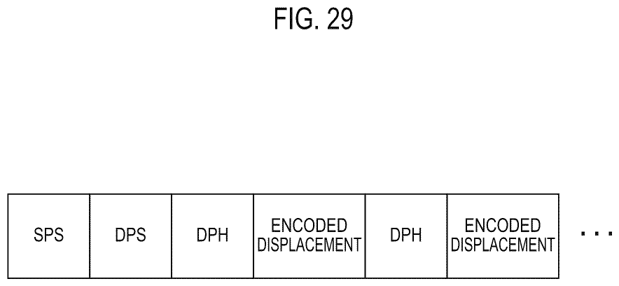

Hereinafter, an example of a configuration of a displacement bit stream will be described with reference to FIG. 29. FIG. 29 is a diagram illustrating an example of a configuration of a displacement bit stream.

As illustrated in FIG. 29, firstly, the displacement bit stream may include a displacement parameter set (DPS) which is a set of control information related to decoding of the displacement.

Second, the displacement bit stream may include a displacement patch header (DPH) that is a set of control information corresponding to the patch.

Third, the displacement bit stream may contain the encoded displacement which, next to the DPH, constitutes a patch.

As described above, the displacement bit stream has a configuration in which the DPH and the DPS correspond to each encoded displacement one by one.

Note that the configuration in FIG. 29 is merely an example. If the DPH and the DPS are configured to correspond to each encoded displacement, elements other than the above may be added as constituent elements of the displacement bit stream.

For example, as illustrated in FIG. 29, the displacement bit stream may include a sequence parameter set (SPS).

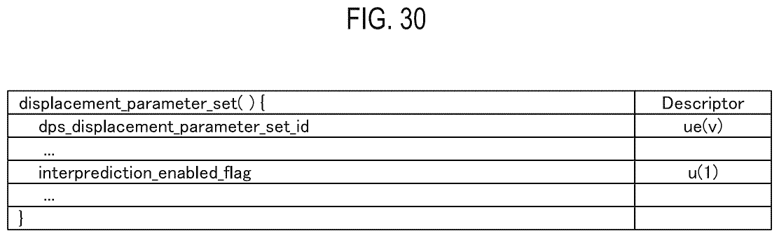

FIG. 30 is a diagram illustrating an example of a syntax configuration of a DPS.

Note that the Descriptor column in FIG. 30 indicates how each syntax is encoded.

Further, in FIG. 30, ue(v) means an unsigned 0-order exponential-Golomb code, and u(n) means a n-bit flag.

In a case where there are a plurality of DPSs, the DPS includes at least DPS id information (dps_displacement_parameter_set_id) for identifying each DPS.

Further, the DPS may include a flag (interprediction_enabled_flag) that controls whether to perform inter-prediction.

For example, when interprediction_enabled_flag is 0, it may be defined that inter-prediction is not performed, and when interprediction_enabled_flag is 1, it may be defined that inter-prediction is performed. When interprediction_enabled_flag is not included, it may be defined that inter-prediction is not performed.

The DPS may include a flag (dct_enabled_flag) that controls whether to perform the inverse DCT.

For example, when dct_enabled_flag is 0, it may be defined that the inverse DCT is not performed, and when dct_enabled_flag is 1, it may be defined that the inverse DCT is performed. When dct_enabled_flag is not included, it may be defined that the inverse DCT is not performed.

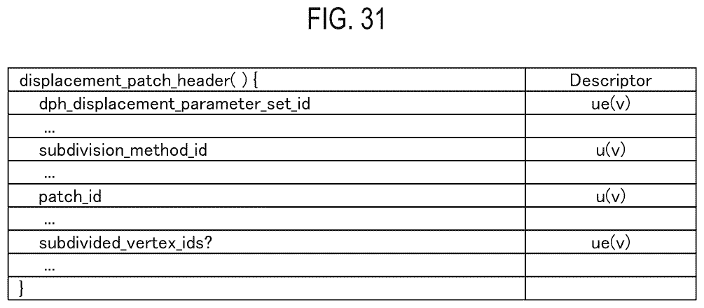

FIG. 31 is a diagram illustrating an example of a syntax configuration of the DPH.

As illustrated in FIG. 31, the DPH includes at least DPS id information for designating a DPS corresponding to each DPH.

The inverse quantization unit 206B is configured to generate and output a transformed coefficient by inversely quantizing the level value decoded by the decoding unit 206A.

The inverse wavelet transform unit 206C is configured to generate and output a prediction residual by applying an inverse wavelet transform to the transformed coefficient generated by the inverse quantization unit 206B.

### (Inter Prediction Unit 206E)

The inter prediction unit 206E is configured to generate and output a predicted displacement by performing inter-prediction using the decoded displacement of the reference frame read from the frame buffer 206F.

The inter prediction unit 206E is configured to perform such inter-prediction only in a case where interprediction_enabled_flag is 1.

The inter prediction unit 206E may perform inter-prediction in the spatial domain or may perform inter-prediction in the frequency domain. In the inter-prediction, bidirectional prediction may be performed using a past reference frame and a future reference frame in terms of time.

FIG. 28 is an example of functional blocks of the inter prediction unit 206E in a case where inter-prediction is performed in the spatial domain.

In a case where inter-prediction is performed in the spatial domain, the inter prediction unit 206E may determine the predicted displacement of the subdivided vertex in the target frame with reference to the decoded displacement of the corresponding subdivided vertex in the reference frame as it is.

Alternatively, the predicted displacement of a certain subdivided vertex in the target frame may be probabilistically determined according to the normal distribution in which the average and the variance are estimated using the decoded displacements of the corresponding subdivided vertices in the plurality of reference frames. In this case, the variance may be uniquely determined only by the average as zero.

Alternatively, the predicted displacement of a certain subdivided vertex in the target frame may be determined based on a regression curve in which the time is estimated as an explanatory variable and the displacement is estimated as an objective variable using the decoded displacements of the corresponding subdivided vertices in the plurality of reference frames.

In the mesh encoding device 100, the order of the decoded displacements may be rearranged for each frame in order to improve the encoding efficiency.

In such a case, the inter prediction unit 206E may be configured to perform inter-prediction on the rearranged decoded displacement.

A correspondence of subdivided vertices between the reference frame and the frame to be decoded is indicated by the control information.

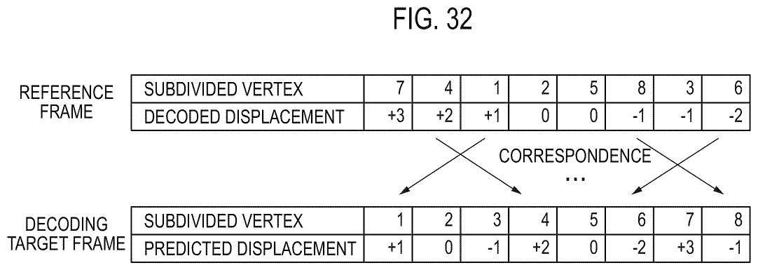

FIG. 32 is a diagram for explaining an example of a correspondence of subdivided vertices between a reference frame and a frame to be decoded in a case where inter-prediction is performed in a spatial domain.

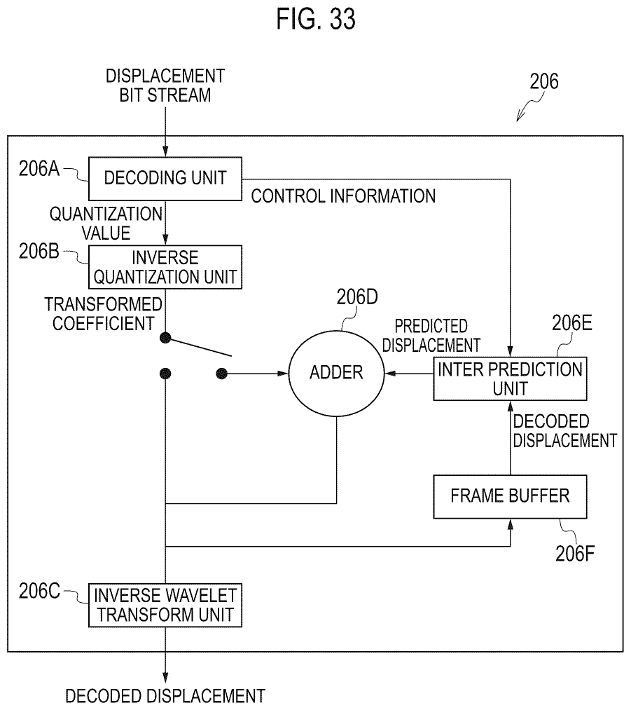

FIG. 33 is an example of functional blocks of the inter prediction unit 206E in a case where inter-prediction is performed in the frequency domain.

In a case where inter-prediction is performed in the frequency domain, the inter prediction unit 206E may determine the predicted wavelet transformed coefficient of the frequency in the frame to be decoded with reference to the decoded wavelet transformed coefficient of the corresponding frequency in the reference frame as it is.

The inter prediction unit 206E may probabilistically perform inter-prediction according to a normal distribution in which the average and the variance are estimated using the decoded displacements or decoded wavelet transformed coefficients of the subdivided vertices in the plurality of reference frames.

The inter prediction unit 206E may perform inter-prediction based on a regression curve in which time is estimated as an explanatory variable and a displacement is estimated as an objective variable, using a decoded displacement or a decoded wavelet transformed coefficient of the subdivided vertices in a plurality of reference frames.

The inter prediction unit 206E may be configured to bidirectionally perform inter-prediction using a past reference frame and a future reference frame in terms of time.

In the mesh encoding device 100, the order of the decoding wavelet transformed coefficients may be rearranged for each frame in order to improve the encoding efficiency.

A correspondence of frequencies between the reference frame and the frame to be decoded is indicated by the control information.

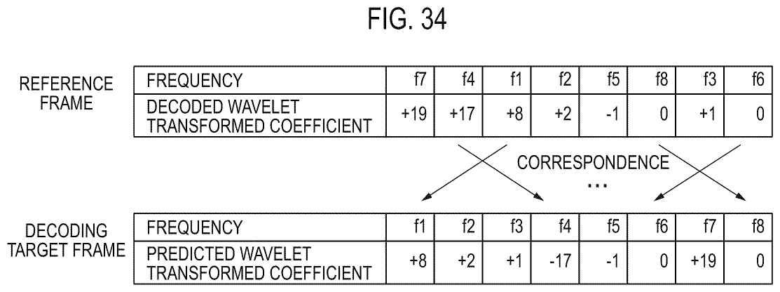

FIG. 34 is a diagram for explaining an example of a correspondence of frequencies between a reference frame and a frame to be decoded in a case where inter-prediction is performed in a frequency domain.

In a case where the subdivision unit 203 divides the base mesh into a plurality of patches, the inter prediction unit 206E is also configured to perform inter-prediction for each divided patch. As a result, the time correlation between frames is increased, and improvement in encoding performance can be expected.

The adder 206D receives the prediction residual from the inverse wavelet transform unit 206C, and receives the predicted displacement from the inter prediction unit 206E.

The adder 206D is configured to calculate and output the decoded displacement by adding the prediction residual and the predicted displacement.

The decoded displacement calculated by the adder 206D is also output to the frame buffer 206F.

The frame buffer 206F is configured to acquire and accumulate the decoded displacement from the adder 206D.

Here, the frame buffer 206F outputs the decoded displacement at the corresponding vertex in the reference frame according to control information (not illustrated).

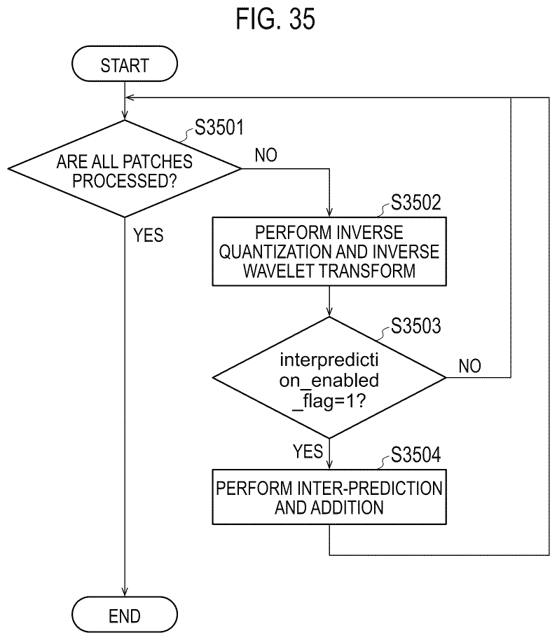

FIG. 35 is a flowchart illustrating an example of an operation of the displacement decoding unit 206.

As illustrated in FIG. 35, in step S3501, the displacement decoding unit 206 determines whether the present processing is completed for all the patches.

In the case of Yes, the present operation ends, and in the case of No, the present operation proceeds to step S3502.

In step S3502, the displacement decoding unit 206 performs inverse DCT and then performs inverse quantization and inverse wavelet transform on the patch to be decoded.

In step S3503, the displacement decoding unit 206 determines whether interprediction_enabled_flag is 1.

In the case of Yes, the present operation proceeds to step S3504, and in the case of No, the present operation proceeds to step S3501.

In step S3504, the displacement decoding unit 206 performs the above inter-prediction and addition.

### First Modification

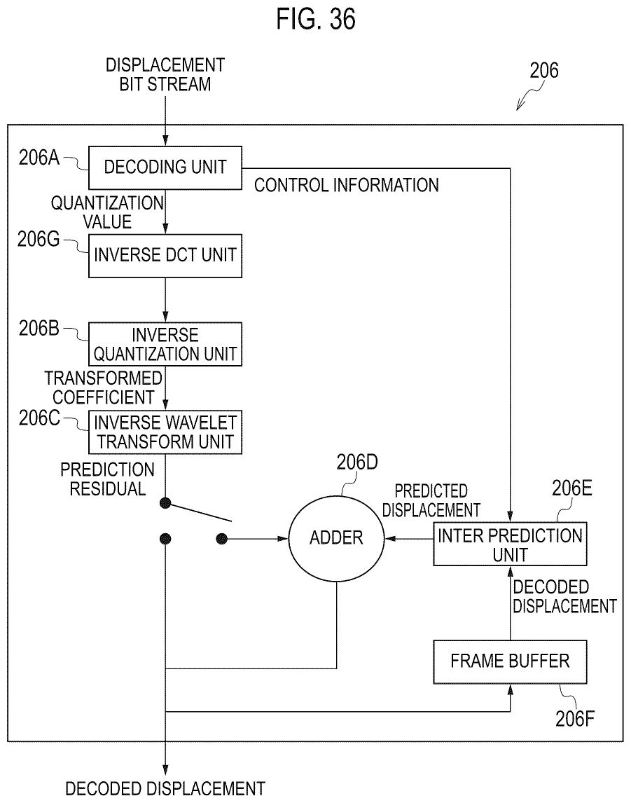

Hereinafter, with reference to FIG. 36, a first modification of the above-described first embodiment will be described focusing on differences from the first embodiment described above.

FIG. 36 is a diagram illustrating an example of functional blocks of the displacement decoding unit 206 according to the present first modification.

As illustrated in FIG. 36, the displacement decoding unit 206 according to the present first modification includes an inverse DCT unit 206G at a subsequent stage of the decoding unit 206A, that is, between the decoding unit 206A and the inverse quantization unit 206B.

That is, in the present first modification, the inverse quantization unit 206B is configured to generate the prediction residual by applying the inverse wavelet transform to the level value output from the inverse DCT unit 206G.

### Second Modification

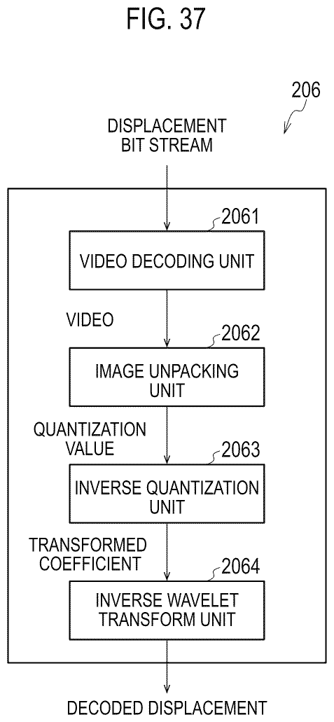

Hereinafter, with reference to FIG. 37, a second modification of the above-described first embodiment will be described focusing on differences from the first embodiment described above.

As illustrated in FIG. 37, the displacement decoding unit 206 according to the present second modification includes a video decoding unit 2061, an image unpacking unit 2062, an inverse quantization unit 2063, and an inverse wavelet transform unit 2064.

The video decoding unit 2061 is configured to output a video by decoding the received displacement bit stream by video coding.

For example, the video decoding unit 2061 may use HEVC described in Reference 1.

Further, the video decoding unit 2061 may use a video coding scheme in which the motion vector is always 0. For example, the video decoding unit 2061 may set the motion vector of HEVC to 0 at all times, and may always use inter-prediction at the same position.

Further, the video decoding unit 2061 may use a video coding scheme in which conversion is always skipped. For example, the video decoding unit 2061 may always set the conversion of HEVC to the conversion skip mode, and may use the video coding scheme without performing the conversion.

The image unpacking unit 2062 is configured to unpack and output the video decoded by the video decoding unit 2061 as a level value for each image (frame).

In the unpacking method, the image unpacking unit 2062 can specify the level value by reverse calculation from the arrangement of the level values in the image indicated by the control information.

For example, the image unpacking unit 2062 may arrange the level values from the high frequency component to the low frequency component in the order of raster operation in the image as the arrangement of the level values.

The inverse quantization unit 2063 is configured to generate and output a transformed coefficient by inversely quantizing the level value generated by the image unpacking unit 2062.

The inverse wavelet transform unit 2064 is configured to generate and output a decoded displacement by applying an inverse wavelet transform to the transformed coefficient generated by the inverse quantization unit 2063.

The mesh encoding device 100 and the mesh decoding device 200 described above may be implemented as programs that cause a computer to execute each function (each step).

According to the present embodiment, it is possible to improve the overall quality of service in video communications, thereby contributing to Goal 9 of the UN-led Sustainable Development Goals (SDGs) which is to “build resilient infrastructure, promote inclusive and sustainable industrialization and foster innovation”.

1. A mesh decoding device comprising:
a circuit that decodes a displacement bit stream to generate and output a displacement, wherein
the circuit:
outputs a video by decoding the displacement bit stream by video encoding,
develops and outputs the video as a level value for each image,
generates a transformed coefficient by inversely quantizing the level values, and
generates the displacement by applying an inverse wavelet transform to the transformed coefficient.

2. The mesh decoding device according to claim 1, wherein
the video decoding unit is configured to output a video by performing decoding using a video coding method in which a motion vector is constantly zero.

3. The mesh decoding device according to claim 1, wherein
the video decoding unit is configured to output a video by performing decoding using a video coding method in which conversion is constantly skipped.

4. A mesh decoding method comprising:
outputting a video by decoding a displacement bit stream by a video coding method;
generating a level value by developing the video for each image;
generating a transformed coefficient by inversely quantizing the level values; and
generating a displacement by applying an inverse wavelet transform to the transformed coefficient.

5. A program stored on a non-transitory computer-readable medium for causing a computer to function as a mesh decoding device,
the mesh decoding device including circuit that decode a displacement bit stream to generate and output a displacement, wherein
the circuit:
outputs a video by decoding the displacement bit stream by video encoding,
outputs a level value by developing the video for each image,
generates a transformed coefficient by inversely quantizing the level values, and
s generates the displacement by applying an inverse wavelet transform to the transformed coefficient.
